(19) United States
(12) Patent Application Publication
(10) Pub. No.: US 2025/0029826 A1
(43) Pub. Date: Jan. 23, 2025

(54) Mass Spectrometer

(71) Applicant: SHIMADZU CORPORATION, Kyoto-shi (JP)

(72) Inventors: Koichi KIMURA, Kyoto-shi (JP); Ryoji NAKATSUKA, Kyoto-shi (JP); Masaru NISHIGUCHI, Kyoto-shi (JP)

(21) Appl. No.: 18/764,432

(22) Filed: Jul. 5, 2024

(30) Foreign Application Priority Data
Jul. 20, 2023 (JP) 2023-118283

(51) Int. Cl. H01J 49/16; H01J 49/06; H01J 49/24

(52) U.S. Cl. CPC H01J 49/165; H01J 49/063; H01J 49/24

(57) ABSTRACT

A mass spectrometer includes an ion source, an ion introduction portion, a reflecting electrode arranged at a position opposed to an introduction port of the ion introduction portion with a spray flow lying therebetween, a first focusing electrode arranged at a position opposed to the reflecting electrode with the spray flow lying therebetween, a second focusing electrode arranged at a position opposed to the reflecting electrode with the spray flow lying therebetween, the second focusing electrode focusing ions focused by the first focusing electrode toward the introduction port, and a voltage application unit that applies a voltage to each electrode. The voltage application unit applies a voltage to each electrode to form electric field where ions are directed toward the first focusing electrode, directed from the first focusing electrode toward the second focusing electrode, and directed from the second focusing electrode toward the introduction port.

### CROSS REFERENCE TO RELATED APPLICATIONS

This nonprovisional application is based on Japanese Patent Application No. 2023-118283 filed with the Japan Patent Office on Jul. 20, 2023, the entire contents of which are hereby incorporated by reference.

### BACKGROUND OF THE INVENTION

### Field of the Invention

The present disclosure relates to a mass spectrometer. More particularly, the present disclosure relates to a mass spectrometer that generates ions by an atmospheric pressure ionization method and separates and detects generated ions in accordance with a mass-to-charge ratio.

### Description of the Background Art

An atmospheric pressure ionization method such as electrospray ionization, atmospheric pressure chemical ionization, and atmospheric pressure photo ionization has been known as a method of ionizing a compound in a liquid sample in a mass spectrometer. In the mass spectrometer including an ion source based on the atmospheric pressure ionization method, ions generated in an ionization chamber substantially in an atmospheric-pressure atmosphere should be introduced into a vacuum chamber maintained in a vacuum atmosphere. In order to improve analysis sensitivity in such an analysis apparatus, two points which are increase in amount of ions generated in the ionization chamber and improvement in efficiency in introduction of ions from the ionization chamber into the vacuum chamber are particularly important.

Japanese Patent No. 6593548 discloses a mass spectrometer in which, in order to improve efficiency in introduction of ions from an ionization chamber into a vacuum chamber, a reflecting electrode and a focusing electrode are arranged in the ionization chamber with a spray flow ejected from an ionization probe lying therebetween and an inlet end of a heated capillary for introducing ions into the vacuum chamber is inserted into an opening portion of the focusing electrode.

### SUMMARY OF THE INVENTION

According to the mass spectrometer disclosed in Japanese Patent No. 6593548, reflecting electric field for reflecting and deflecting ions is created within a space between the reflecting electrode and the focusing electrode and focusing electric field for focusing ions to the inlet end is created in an area near the inlet end. Therefore, efficiency in introduction of ions from the ionization chamber into the vacuum chamber can be enhanced.

In intake of ions from the ion introduction portion implemented by the heated capillary, efficiency in intake of ions can be enhanced by focusing ions to a diameter approximately as large as an aperture of the introduction port at the end of the ion introduction portion. Efficiency in intake of ions can be enhanced also by increasing the aperture of the introduction port. Increase in aperture of the introduction port, however, necessitates enhancement of performance of a vacuum pump or leads to higher possibility of a failure or the like due to transfer of an impurity or the like other than ions from the introduction port into the vacuum chamber. Therefore, ions should further be focused at the end of the ion introduction portion.

The present disclosure was made to solve such a problem, and an object thereof is to improve efficiency in taking ions into an ion introduction portion.

A mass spectrometer in the present disclosure is a mass spectrometer that generates ions by an atmospheric pressure ionization method and separates and detects generated ions in accordance with a mass-to-charge ratio. The mass spectrometer includes an ion source including a probe that sprays a liquid sample into an ionization chamber which is in an atmospheric-pressure atmosphere, an ion introduction portion where ions in a sample droplet sprayed from the probe are introduced from the ionization chamber toward a vacuum chamber in a direction intersecting with a direction of spray of the liquid sample from the probe, a reflecting electrode arranged at a position opposed to an introduction port of the ion introduction portion with a spray flow lying between the introduction port and the reflecting electrode, a first focusing electrode arranged at a position opposed to the reflecting electrode with the spray flow lying between the reflecting electrode and the first focusing electrode, the first focusing electrode focusing ions reflected or deflected by the reflecting electrode, a second focusing electrode arranged at a position opposed to the reflecting electrode with the spray flow lying between the reflecting electrode and the second focusing electrode, the second focusing electrode focusing ions focused by the first focusing electrode toward the introduction port, and a voltage application unit that applies a voltage to each electrode. The voltage application unit applies a voltage to each electrode to form electric field where ions in the spray flow are directed toward the first focusing electrode, directed from the first focusing electrode toward the second focusing electrode, and directed from the second focusing electrode toward the introduction port.

The foregoing and other objects, features, aspects and advantages of this invention will become more apparent from the following detailed description of this invention when taken in conjunction with the accompanying drawings.

### BRIEF DESCRIPTION OF THE DRAWINGS

FIG. 1 is a schematic diagram showing an overall configuration of a mass spectrometer according to a first example.

FIG. 2 is a schematic diagram showing a general configuration of the inside of an ionization chamber according to the first example.

FIG. 3 is a schematic diagram showing a general configuration of the inside of an ionization chamber according to a second example.

FIG. 4 is a diagram showing a result of simulation of ion orbits in the ionization chamber according to the second example.

FIG. 5 is a diagram showing results of simulation in the second example and a comparative example, which indicate positions in an introduction port which ions reached.

FIG. 6 is a schematic diagram showing a general configuration of the inside of an ionization chamber according to the comparative example.

FIG. 7 is a schematic diagram showing a general configuration of the inside of an ionization chamber according to a third example.

FIG. 8 is a diagram showing a result of simulation of ion orbits in the ionization chamber according to the third example.

FIG. 9 is a diagram showing results of simulation in the third example and the comparative example, which indicate positions in the introduction port which ions reached.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

### FIRST EXAMPLE

### Overall Configuration of Mass Spectrometer

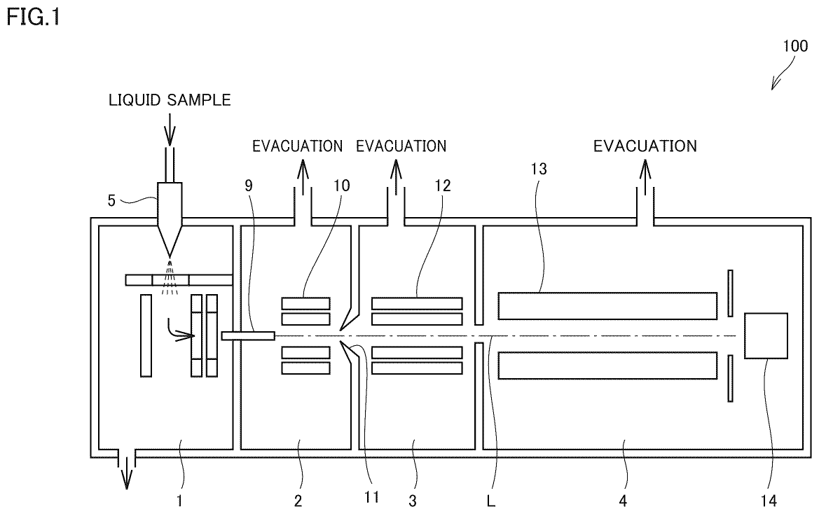

FIG. 1 is a schematic diagram showing an overall configuration of a mass spectrometer according to a first example. A mass spectrometer 100 is configured as a multi-stage differential pumping system in which two chambers of a first intermediate vacuum chamber 2 and a second intermediate vacuum chamber 3 are provided between an ionization chamber 1 substantially in an atmospheric-pressure atmosphere and an analysis chamber 4 in a high vacuum atmosphere evacuated by a not-shown high-performance vacuum pump.

In ionization chamber 1, an ion source including a probe 5 for electrospray ionization (ESI) is arranged. The ion source is not limited to the ESI ion source, and an ion source adapted to another atmospheric pressure ionization method such as atmospheric pressure chemical ionization (APCI) or atmospheric pressure photo ionization (APPI) may be applicable.

In ionization chamber 1, a liquid sample containing a sample component is sprayed from probe 5 while it is being charged. A droplet sprayed from a tip end of probe 5 becomes finer as a result of contact with ambient atmosphere, and the sample component is ionized in a process of evaporation of a solvent from the droplet.

Ionization chamber 1 and first intermediate vacuum chamber 2 communicate with each other through a cylindrical ion introduction portion 9. Ion introduction portion 9 is implemented, for example, by a heated capillary. There is a pressure difference between opposing opening ends of ion introduction portion 9. Owing to this pressure difference, a gas flow that flows from ionization chamber 1 through ion introduction portion 9 into first intermediate vacuum chamber 2 is formed. Ions derived from the sample component and generated in ionization chamber 1 are suctioned into ion introduction portion 9 over the gas flow produced mainly by the pressure difference and sent into first intermediate vacuum chamber 2 together with the gas flow.

In first intermediate vacuum chamber 2, a multipole ion guide 10 arranged to surround an ion optical axis L which is an axis of cylindrical ion introduction portion 9 is provided. A wall that separates first intermediate vacuum chamber 2 and second intermediate vacuum chamber 3 from each other is provided with a skimmer 11 provided with an orifice small in diameter. Ions sent into first intermediate vacuum chamber 2 are focused in the vicinity of the orifice in skimmer 11 owing to an action of electric field formed by ion guide 10 and sent into second intermediate vacuum chamber 3 through skimmer 11.

In second intermediate vacuum chamber 3, a multipole (for example, octupole) ion guide 12 arranged to surround ion optical axis L is provided. Ions sent into second intermediate vacuum chamber 3 are focused owing to an action of high frequency (RF) electric field formed by ion guide 12 and sent into analysis chamber 4.

In analysis chamber 4, a quadrupole mass filter 13 arranged to surround ion optical axis L and an ion detector 14 arranged on ion optical axis L are provided. Ions sent into analysis chamber 4 are introduced into a space in a direction of a major axis (a direction of ion optical axis L) of quadruple mass filter 13, and owing to the action of electric field formed by an RF voltage applied to quadrupole mass filter 13 and a direct current (DC) voltage, only ions having a specific mass-to-charge ratio pass through quadrupole mass filter 13 and reach ion detector 14. Ion detector 14 generates a detection signal in accordance with an amount of ions that have reached the ion detector, and transmits the detection signal to a not-shown data processing apparatus.

As set forth above, in mass spectrometer 100, ions derived from the sample component and generated in ionization chamber 1 pass through first intermediate vacuum chamber 2 and second intermediate vacuum chamber 3 and are detected in analysis chamber 4. Therefore, analysis at high sensitivity can be achieved by making a larger amount of ions finally incident on ion detector 14 while loss of ions generated in ionization chamber 1 is minimized.

### General Configuration of Ion Source

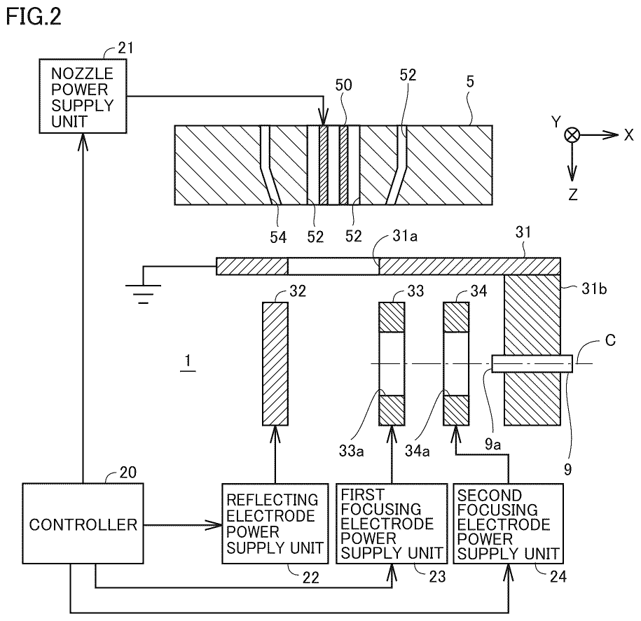

FIG. 2 is a schematic diagram showing a general configuration of the inside of the ionization chamber according to the first example. A direction of injection along a central axis of a spray flow from probe 5 is defined as a Z-axis direction below, a direction of suction of ions along the central axis of ion introduction portion 9 orthogonal thereto is defined as an X-axis direction, and a direction orthogonal to the X-axis direction and the Z-axis direction is defined as a Y-axis direction.

In ionization chamber 1, an auxiliary electrode 31, a reflecting electrode 32, a first focusing electrode 33, and a second focusing electrode 34 are arranged. Mass spectrometer 100 includes a controller 20 that controls the entire mass spectrometer 100, a nozzle power supply unit 21 that applies a voltage to probe 5, a reflecting electrode power supply unit 22 that applies a voltage to reflecting electrode 32, a first focusing electrode power supply unit 23 that applies a voltage to first focusing electrode 33, and a second focusing electrode power supply unit 24 that applies a voltage to second focusing electrode 34.

Auxiliary electrode 31 is arranged at a position opposed to the tip end of probe 5. Auxiliary electrode 31 is an electrode in a form of a flat plate where an opening 31a is provided. Auxiliary electrode 31 is arranged such that a flat surface thereof is in parallel to an X-Y plane. In addition, in order to have a spray flow of a sample droplet from probe 5 pass through circular opening 31a, auxiliary electrode 31 is arranged such that the tip end of probe 5 is located in opening 31a when it is viewed from the Z-axis direction in a plan view.

Reflecting electrode 32 is arranged at a position opposed to an introduction port 9a which is an inlet end of ion introduction portion 9, with the spray flow of the sample droplet from probe 5 lying therebetween. Reflecting electrode 32 is an electrode in a form of a flat plate and arranged such that a flat surface thereof is in parallel to a Y-Z plane.

First focusing electrode 33 is arranged at a position opposed to reflecting electrode 32, with the spray flow of the sample droplet from probe 5 lying therebetween. First focusing electrode 33 is arranged to surround a central axis C that is in parallel to an X axis which is the direction of suction of ions and passes through the center of introduction port 9a. For example, first focusing electrode 33 is an electrode in a form of a flat plate where a circular opening to serve as a first transmission channel 33a is provided. First focusing electrode 33 is arranged such that a flat surface thereof is in parallel to the Y-Z plane. First focusing electrode 33 is arranged such that central axis C thereof coincides with a central axis of first transmission channel 33a. In other words, first focusing electrode 33 defines first transmission channel 33a. A method of definition of first transmission channel 33a by first focusing electrode 33 is not limited to the method of provision of an opening in first focusing electrode 33.

Second focusing electrode 34 is arranged at a position opposed to reflecting electrode 32, with the spray flow of the sample droplet from probe 5 lying therebetween. Second focusing electrode 34 is arranged to surround central axis C that is in parallel to the X axis which is the direction of suction of ions and passes through the center of introduction port 9a to define a second transmission channel 34a. Second focusing electrode 34 is, for example, an ion funnel type electrode or an ion guide type electrode to which an RF voltage is applied or a cylindrical electrode to which a DC voltage is applied. One example in which second focusing electrode 34 is an electrode to which an RF voltage is applied and one example in which the second focusing electrode is an electrode to which a DC voltage is applied will be described later.

First focusing electrode 33, second focusing electrode 34, and ion introduction portion 9 are arranged such that an inner edge of second transmission channel 34a is located as being flush with or on an inner side of an inner edge of first transmission channel 33a and introduction port 9a is located as being flush with or on an inner side of the inner edge of second transmission channel 34a when introduction port 9a is viewed from reflecting electrode 32 in the plan view. For example, a smallest diameter of first transmission channel 33a defined by first focusing electrode 33 is equal to or larger than a largest diameter of second transmission channel 34a defined by second focusing electrode 34. The smallest diameter of second transmission channel 34a is equal to or larger than a diameter of introduction port 9a.

Controller 20 controls the entire mass spectrometer 100 and controls a voltage to be generated in each power supply unit. Controller 20 includes, as its main constituent elements, a central processing unit (CPU) which is a processor, a storage where a program and data are stored, and a communication interface (I/F), although they are not shown. The constituent elements are connected to one another through a data bus.

The storage includes a read only memory (ROM), a random access memory (RAM), and a hard disk drive (HDD). A program to be executed by the CPU is stored in the ROM. Data generated by execution of a program by the CPU and data inputted through the communication I/F are temporarily stored in the RAM. The RAM can function as a temporary data memory used as a work area. The HDD is a non-volatile storage device. Instead of the HDD, a semiconductor storage device such as a flash memory may be adopted.

A program stored in the ROM may be stored in a storage medium and distributed as a program product. Alternatively, the program may be provided by an information provider as a program product that can be downloaded through what is called the Internet.

The storage medium is not limited to a digital versatile disk read only memory (DVD-ROM), a compact disc read-only memory (CD-ROM), a flexible disk (FD), or a hard disk, but may be a medium that carries a program in a fixed manner such as a magnetic tape, a cassette tape, an optical disc (a magnetic optical disc (MO)/a mini disc (MD)/a digital versatile disc (DVD)), an optical card, or a semiconductor memory such as a mask ROM, an electronically programmable read-only memory (EPROM), an electronically erasable programmable read-only memory (EEPROM), or a flash ROM. A recording medium is a non-transitory medium from which a computer can read a program or the like.

Probe 5 includes a capillary 50 through which a liquid sample passes, a nebulizer gas pipe 52 arranged to surround capillary 50, and a heated gas pipe 54 arranged to surround nebulizer gas pipe 52. Nozzle power supply unit 21 applies to capillary 50, a voltage for providing charges to the liquid sample sprayed from probe 5. A DC voltage as high as several kilovolts (kV) at the maximum is applied from nozzle power supply unit 21 to capillary 50.

The charged liquid sample is sprayed as fine droplets by being assisted by nebulizer gas ejected from nebulizer gas pipe 52. In addition, vaporization of a solvent from droplets is accelerated by heated gas at a high temperature ejected from heated gas pipe 54. A flow rate of nebulizer gas is not lower than 0.5 L/min. and not higher than 3 L/min. The flow rate of heated gas is not lower than 3 L/min. and not higher than 20 L/min.

As the liquid sample is sprayed from probe 5 while the voltage is applied by nozzle power supply unit 21 to capillary 50 (probe 5), the positively or negatively charged liquid sample is sprayed from probe 5 in the Z-axis direction. The charged nebulized liquid sample passes through opening 31a in auxiliary electrode 31 along a gas flow together with nebulizer gas, and is sent to a space lying between reflecting electrode 32 and first focusing electrode 33.

Controller 20 controls reflecting electrode power supply unit 22, first focusing electrode power supply unit 23, and second focusing electrode power supply unit 24 to form electric field such that ions in the gas flow (spray flow) sent to the space lying between reflecting electrode 32 and first focusing electrode 33 are directed toward first focusing electrode 33, directed from first focusing electrode 33 toward second focusing electrode 34, and directed from second focusing electrode 34 toward introduction port 9a.

For example, when the liquid sample is sprayed from probe 5 so as to positively be charged, a voltage V1 to be applied to reflecting electrode 32, a voltage V2 to be applied to first focusing electrode 33, a voltage V3 to be applied to second focusing electrode 34, and a voltage V4 to be applied to ion introduction portion 9 are set such that voltage V1 is higher than voltage V2, voltage V2 is higher than voltage V3, and voltage V3 is higher than voltage V4. In other words, the voltage applied to each electrode is set such that relation among voltages V1 to V4 satisfies relation of V1>V2>V3>V4. In the present embodiment, a conductive wall 31b electrically connected to auxiliary electrode 31 and ion introduction portion 9 is grounded, and a potential thereof is, for example, 0 V. In other words, V4 is set to 0 V. Since auxiliary electrode 31 is grounded in the present embodiment, electric fields in spaces on opposing sides with auxiliary electrode 31 lying therebetween (the space on a side of probe 5 and the space on a side of reflecting electrode 32) hardly affect each other.

Though an example in which positive ions are to be measured is assumed in the description below, in an example where negative ions are to be measured, a voltage of a reverse polarity is applied to each electrode. In this case, voltages V1 to V4 are set such that voltage V1 is lower than voltage V2, voltage V2 is lower than voltage V3, and voltage V3 is lower than voltage V4. In other words, the voltage to be applied to each electrode is set such that relation among voltages V1 to V4 satisfies relation of V1<V2<V3<V4.

By setting each voltage as described above, reflecting electric field where positive ions are guided in a direction from reflecting electrode 32 toward first focusing electrode 33 is formed in the space lying between reflecting electrode 32 and first focusing electrode 33 to which the charged nebulized liquid sample is sent.

Since relation of V2>V3 is set, focusing electric field where positive ions are guided in a direction from the inner edge of first transmission channel 33a toward the central axis (the direction of central axis C) of second transmission channel 34a is also formed. In addition, a potential difference |V1−V3| between reflecting electrode 32 and second focusing electrode 34 is larger than a potential difference |V1−V2| between reflecting electrode 32 and first focusing electrode 33, and hence reflecting electric field where ions are more strongly guided from reflecting electrode 32 toward second focusing electrode 34 is formed.

Since relation of V3>V4 is set, focusing electric field where positive ions are guided in a direction from the inner edge of second transmission channel 34a to the center (the direction of central axis C) of introduction port 9a is also formed. In addition, a potential difference |V1−V4| between reflecting electrode 32 and ion introduction portion 9 is larger than the potential difference |V1−V3| between reflecting electrode 32 and second focusing electrode 34, and hence reflecting electric field where ions are more strongly guided from reflecting electrode 32 toward ion introduction portion 9a is formed.

Ions having positive charges in the spray flow that has passed through opening 31a in auxiliary electrode 31 and small charged droplets that have not been ionized and the like are guided in the direction toward first focusing electrode 33 owing to the action of reflecting electric field and separated from the spray flow (gas flow). The separated charged droplets and the like are focused toward a portion around introduction port 9a by focusing electric field directed from the inner edge of first transmission channel 33a toward the central axis of second transmission channel 34a, that is, the center of introduction port 9a.

Furthermore, in the present embodiment, second focusing electrode 34 in addition to first focusing electrode 33 is arranged and focusing electric field extending from the inner edge of second transmission channel 34a toward the center of introduction port 9a is formed, so that charged droplets and the like separated and focused can further be focused to be directed toward the center of introduction port 9a, efficiency in taking ions into ion introduction portion 9 can further be improved, and higher sensitivity of mass spectrometer 100 can be achieved.

### SECOND EXAMPLE

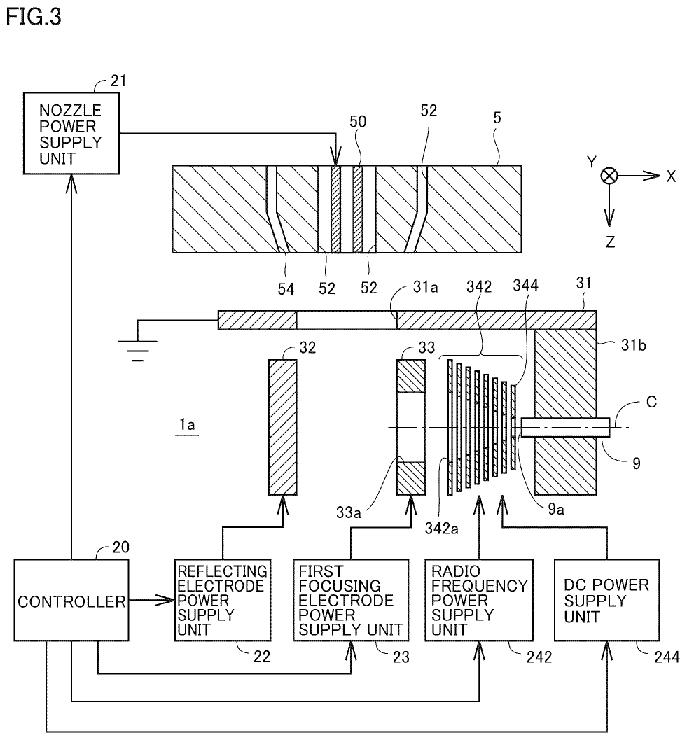

FIG. 3 is a schematic diagram showing a general configuration of the inside of an ionization chamber according to a second example. A mass spectrometer according to the second example is different from the mass spectrometer according to the first example in including an RF electrode 342 as second focusing electrode 34 and including a high frequency power supply unit 242 and a DC power supply unit 244 as second focusing electrode power supply unit 24. A feature different from the feature in ionization chamber 1 according to the first example, among features in an ionization chamber la according to the second example will be described and description of the feature in common will not be provided.

First focusing electrode 33, RF electrode 342, and ion introduction portion 9 are arranged in this order from the side of reflecting electrode 32 along central axis C. In other words, RF electrode 342 is arranged between first focusing electrode 33 and ion introduction portion 9. Since positions of first focusing electrode 33, RF electrode 342, and ion introduction portion 9 are not superimposed on one another, each component can readily be provided.

RF electrode 342 is an ion funnel type electrode including a plurality of ring electrodes 344 arranged at equal intervals along central axis C. RF electrode 342 may be a multipole ion guide type electrode formed from an even number (normally four or eight) of rod electrodes extending in the direction of central axis C and arranged at equal angular intervals around the ion optical axis. In the second example, RF electrode 342 to serve as second focusing electrode 34 can also be defined as an electrode group composed of a plurality of electrodes.

As ring electrode 344 is closer to ion introduction portion 9 among the plurality of ring electrodes 344, it is smaller in opening. Ions pass through a second transmission channel 342a which is a space in a form of a frustum of a cone surrounded by ring electrodes 344. Ring electrode 344 closest to first focusing electrode 33 among the plurality of ring electrodes 344 has an inner diameter equal to or smaller than the smallest diameter of first transmission channel 33a in first focusing electrode 33. Ring electrode 344 smallest in inner diameter among the plurality of ring electrodes 344 has the inner diameter equal to or larger than the diameter of introduction port 9a. In other words, first focusing electrode 33, RF electrode 342 (the plurality of ring electrodes 344), and ion introduction portion 9 are arranged such that the inner edge of second transmission channel 342a is located as being flush with or on an inner side of the inner edge of first transmission channel 33a and introduction port 9a is located as being flush with or on an inner side of the inner edge of second transmission channel 342a when introduction port 9a is viewed from reflecting electrode 32 in the plan view.

RF voltages reverse in phase to each other are applied by high frequency power supply unit 242 to two ring electrodes 344 adjacent in the X-axis direction. RF electric field that focuses ions to second transmission channel 342a which is the space in the form of the frustum of the cone surrounded by ring electrodes 344 is thus formed.

DC voltages varied stepwise in the X-axis direction are applied by DC power supply unit 244 to the plurality of ring electrodes 344 such that a DC potential gradient that accelerates ions focused by first focusing electrode 33 in the direction toward introduction port 9a is formed.

A DC voltage is applied to reflecting electrode 32 and first focusing electrode 33. For example, when the liquid sample is sprayed from probe 5 to positively be charged, voltage V1 to be applied to reflecting electrode 32, voltage V2 to be applied to first focusing electrode 33, a DC voltage V31 to be applied to ring electrode 344 arranged closest to first focusing electrode 33, a DC voltage V32 to be applied to ring electrode 344 arranged closest to introduction port 9a, and voltage V4 to be applied to ion introduction portion 9 are set such that voltage V1 is higher than voltage V2, voltage V2 is higher than voltage V31, voltage V31 is higher than voltage V32, and voltage V32 is higher than voltage V4. In other words, the DC voltage to be applied satisfies relation of V1>V2>V31>V32>V4.

Electric field extending from reflecting electrode 32 toward first focusing electrode 33, extending from first focusing electrode 33 toward RF electrode 342, and extending from RF electrode 342 toward introduction port 9a is formed in the space lying between reflecting electrode 32 and first focusing electrode 33 where the charged nebulized liquid sample is sent. Furthermore, as a result of application of the RF voltage to RF electrode 342 by high frequency power supply unit 242, RF electric field is formed in second transmission channel 342a and a substantial potential barrier that traps ions around central axis C is formed. Ions can thus be focused toward central axis C.

Since RF electric field that focuses ions toward central axis C and a potential gradient that accelerates ions directed toward introduction port 9a are formed in second transmission channel 342a, ions sent into second transmission channel 342a are sent in the direction toward introduction port 9a while being focused toward central axis C.

As set forth above, in the mass spectrometer according to the second example, RF electric field which is focusing electric field for focusing toward central axis C is formed, and this RF electric field can further focus charged droplets and the like separated from the spray flow and focused toward the center of introduction port 9a, efficiency in taking ions into ion introduction portion 9 can further be improved, and higher sensitivity of the mass spectrometer can be achieved.

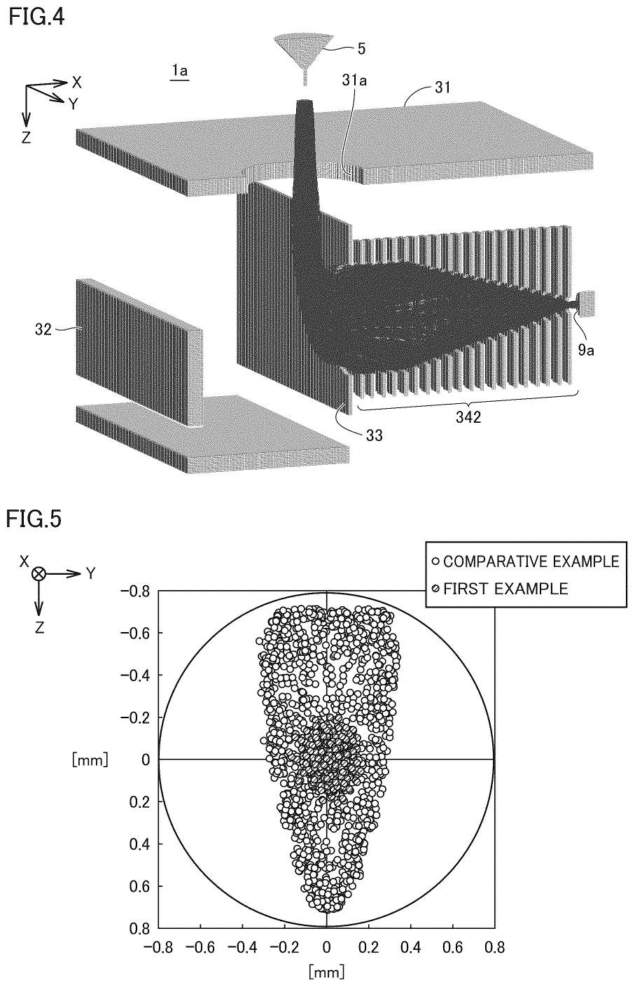

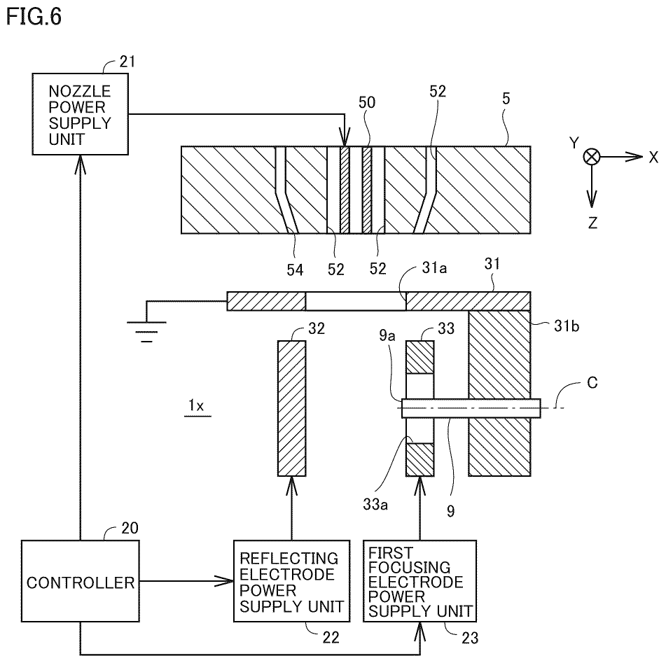

FIG. 4 is a diagram showing a result of simulation of ion orbits in the ionization chamber according to the second example. FIG. 5 is a diagram showing results of simulation in the second example and a comparative example, which indicate positions in the introduction port which ion reached. FIG. 6 is a schematic diagram showing a general configuration of the inside of an ionization chamber according to the comparative example.

Results of the simulation shown in FIGS. 4 and 5 were obtained in the second example by arranging twenty ring electrodes 344 as RF electrode 342, setting a frequency and an amplitude of the RF voltage to be applied to ring electrodes 344 by high frequency power supply unit 242 to 0.6 MHz and 1 kV, respectively, setting voltage V1 to be applied to reflecting electrode 32 to 4 kV, setting voltage V2 to be applied to first focusing electrode 33 to 1 kV, and setting DC voltage V31 to be applied to ring electrode 344 arranged closest to first focusing electrode 33 to 952.5 V such that the voltage to be applied to ring electrode 344 closer to ion introduction portion 9 was lower and the potential difference between adjacent ring electrodes 344 attained to 47.5 V. Voltage V4 to be applied to ion introduction portion 9 was 0 V.

As shown in FIG. 4, all ions could be separated from the gas flow and substantially all ions could be focused toward introduction port 9a.

FIG. 5 shows positions in introduction port 9a which ions reached, and a circular frame in FIG. 5 indicates the inner edge of introduction port 9a. FIG. 5 shows results of the simulation in the comparative example together with the results of the simulation in the second example.

Referring to FIG. 6, a mass spectrometer according to the comparative example is different from the mass spectrometer according to the second example in that RF electrode 342 to serve as second focusing electrode 34 is not arranged in an ionization chamber 1x, high frequency power supply unit 242 and DC power supply unit 244 which are second focusing electrode power supply units 24 are not provided, and first focusing electrode 33 is arranged to surround ion introduction portion 9 in ionization chamber 1x. The results of the simulation shown in FIG. 5 were obtained in the comparative example by setting a voltage to be applied to reflecting electrode 32 to 5 kV and setting a voltage to be applied to the first focusing electrode to 2.5 kV. A voltage to be applied to ion introduction portion 9 was 0 V.

Referring to FIG. 5, being provided with RF electrode 342 to serve as the second focusing electrode, the mass spectrometer according to the second example can achieve improvement in focusing of ions to the center of introduction port 9a as compared with the mass spectrometer according to the comparative example which does not include RF electrode 342 to serve as the second focusing electrode. Since efficiency in taking ions into ion introduction portion 9 can consequently be improved, higher sensitivity of the mass spectrometer can be achieved.

### Ion Source According to Third Example

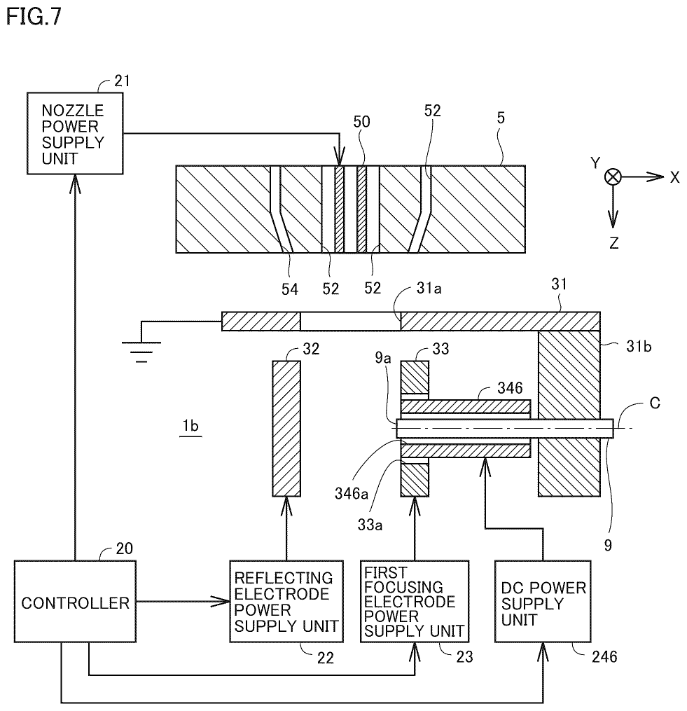

FIG. 7 is a schematic diagram showing a general configuration of the inside of an ionization chamber according to a third example. A mass spectrometer according to the third example is different from the mass spectrometer according to the first example in including a DC electrode 346 as second focusing electrode 34 and including a DC power supply unit 246 as second focusing electrode power supply unit 24. A feature different from the feature in ionization chamber 1 according to the first example, among features in an ionization chamber 1b according to the third example will be described, and description of the feature in common will not be provided.

DC electrode 346 is a cylindrical electrode and arranged such that an axis thereof is located on central axis C. DC electrode 346 is longer in length in the direction of central axis C than first focusing electrode 33 and it is shorter in length in the direction of central axis C than ion introduction portion 9. Since an area where components are not superimposed on each other is thus formed, each component is readily provided.

DC electrode 346 is smaller in inner diameter of a cylinder than first focusing electrode 33 and larger in inner diameter of the cylinder than ion introduction portion 9. DC electrode 346 is arranged in first transmission channel 33a in first focusing electrode 33. In other words, first focusing electrode 33 is arranged to surround DC electrode 346. Ion introduction portion 9 is arranged in a second transmission channel 346a defined by DC electrode 346. In other words, DC electrode 346 is arranged to surround ion introduction portion 9.

First focusing electrode 33, DC electrode 346, and ion introduction portion 9 are thus arranged such that an inner edge of second transmission channel 346a is located on the inner side of the inner edge of first transmission channel 33a and introduction port 9a is located on an inner side of the inner edge of second transmission channel 346a when introduction port 9a is viewed from reflecting electrode 32 in the plan view.

DC voltages are applied to reflecting electrode 32, first focusing electrode 33, and DC electrode 346. For example, when the liquid sample is sprayed from probe 5 to positively be charged, voltage V1 to be applied to reflecting electrode 32, voltage V2 to be applied to first focusing electrode 33, a voltage V33 to be applied to DC electrode 346, and voltage V4 to be applied to ion introduction portion 9 are set such that voltage V1 is higher than voltage V2, voltage V2 is higher than voltage V33, and voltage V33 is higher than voltage V4. In other words, the DC voltage to be applied to each electrode is set such that relation among voltages V1, V2, V33, and V4 satisfies relation of V1 >V2 >V33 >V4 .

Electric field extending from reflecting electrode 32 toward first focusing electrode 33, extending from first focusing electrode 33 toward DC electrode 346, and extending from DC electrode 346 toward introduction port 9a is thus formed in the space lying between reflecting electrode 32 and first focusing electrode 33 to which the charged nebulized liquid sample is sent.

In the third example, DC electrode 346 is provided so that focusing electric field extending from the inner edge of second transmission channel 346a toward the center of introduction port 9a is formed and this focusing electric field can further focus the separated and focused charged droplets or the like toward the center of introduction port 9a, efficiency in taking ions into ion introduction portion 9 can further be improved, and higher sensitivity of the mass spectrometer can be achieved. Use of the DC voltage can facilitate design of a circuit or grounding as compared with an example where an RC voltage is used.

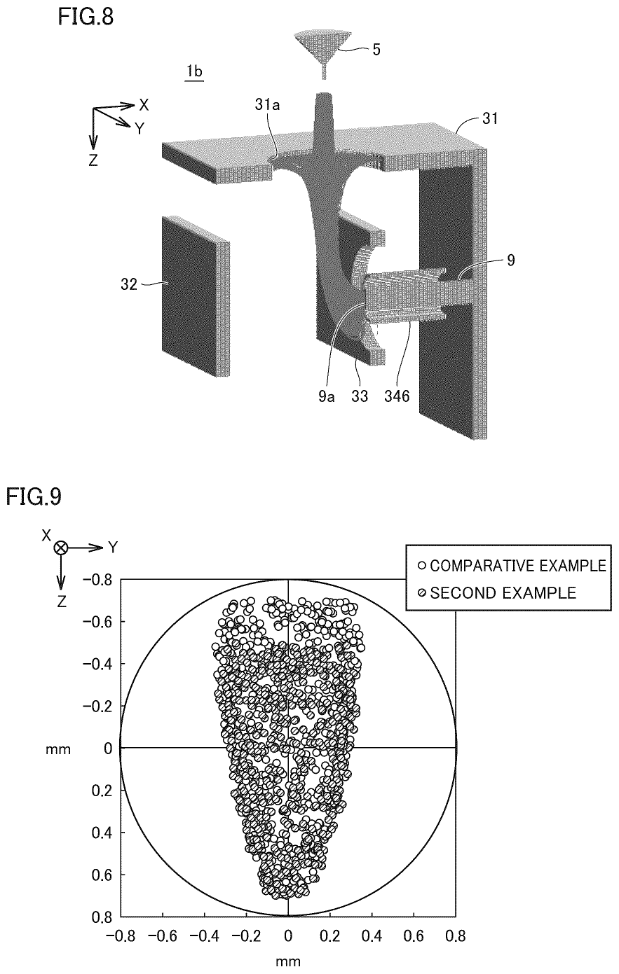

FIG. 8 is a diagram showing a result of simulation of ion orbits in the ionization chamber according to the third example. FIG. 9 is a diagram showing results of simulation in the third example and the comparative example, which indicate positions in the introduction port which ions reached.

The results of the simulation shown in FIGS. 8 and 9 were obtained in the third example by setting voltage V1 to be applied to reflecting electrode 32 to 4 kV, setting voltage V2 to be applied to first focusing electrode 33 to 2 kV, and setting a voltage V33 to be applied to DC electrode 346 to 0.9 kV.

As shown in FIG. 8, all ions could be separated from the gas flow and substantially all ions could be focused toward introduction port 9a.

FIG. 9 shows the positions in introduction port 9a which ions reached, and a circular frame in FIG. 9 indicates the inner edge of introduction port 9a. FIG. 9 shows results of the simulation in the comparative example together with the results of the simulation in the third example. The mass spectrometer according to the comparative example is in common to the mass spectrometer described with reference to FIG. 6, and different from the mass spectrometer according to the third example in not including DC electrode 346 to serve as second focusing electrode 34 and DC power supply unit 246 to serve as second focusing electrode power supply unit 24. The results of the simulation shown in FIG. 9 were obtained in the comparative example by setting the voltage to be applied to reflecting electrode 32 to 5 kV and setting the voltage to be applied to the first focusing electrode to 2.5 kV. The voltage to be applied to ion introduction portion 9 was 0 V.

Referring to FIG. 9, being provided with DC electrode 346 to serve as the second focusing electrode, the mass spectrometer according to the third example can achieve improvement in focusing of ions in the Z-axis direction as compared with the mass spectrometer according to the comparative example which does not include DC electrode 346 to serve as the second focusing electrode. Since efficiency in taking ions into ion introduction portion 9 can consequently be improved, higher sensitivity of the mass spectrometer can be achieved.

### ASPECTS

Each example described above is understood by a person skilled in the art as a specific example of aspects below.

(Clause 1) A mass spectrometer according to one aspect is a mass spectrometer that generates ions by an atmospheric pressure ionization method and separates and detects generated ions in accordance with a mass-to-charge ratio. The mass spectrometer includes an ion source including a probe that sprays a liquid sample into an ionization chamber which is in an atmospheric-pressure atmosphere, an ion introduction portion where ions in a sample droplet sprayed from the probe are introduced from the ionization chamber toward a vacuum chamber in a direction intersecting with a direction of spray of the liquid sample from the probe, a reflecting electrode arranged at a position opposed to an introduction port of the ion introduction portion with a spray flow lying between the introduction port and the reflecting electrode, a first focusing electrode arranged at a position opposed to the reflecting electrode with the spray flow lying between the reflecting electrode and the first focusing electrode, the first focusing electrode focusing ions reflected or deflected by the reflecting electrode, a second focusing electrode arranged at a position opposed to the reflecting electrode with the spray flow lying between the reflecting electrode and the second focusing electrode, the second focusing electrode focusing ions focused by the first focusing electrode toward the introduction port, and a voltage application unit that applies a voltage to an electrode. The voltage application unit may apply a voltage to each electrode to form electric field where ions in the spray flow are directed toward the first focusing electrode, directed from the first focusing electrode toward the second focusing electrode, and directed from the second focusing electrode toward the introduction port.

According to the mass spectrometer according to Clause 1, the second focusing electrode in addition to the first focusing electrode is arranged and electric field extending from the second focusing electrode toward the introduction port is formed, so that ions can be focused to be directed toward a center of the introduction port further than in an example where only the first focusing electrode is arranged. Therefore, efficiency in taking ions into the ion introduction portion can be improved.

(Clause 2) In the mass spectrometer according to Clause 1, the first focusing electrode defines a first transmission channel. The second focusing electrode defines a second transmission channel. The first focusing electrode, the second focusing electrode, and the ion introduction portion may be arranged such that, when the introduction port is viewed from the reflecting electrode in a plan view, an inner edge of the second transmission channel is located as being flush with or on an inner side of an inner edge of the first transmission channel and the introduction port is located as being flush with or on an inner side of the inner edge of the second transmission channel.

According to the mass spectrometer according to Clause 2, ions can be focused to further be directed toward the center of the introduction port and efficiency in taking ions into the ion introduction portion can be improved.

(Clause 3) In the mass spectrometer according to Clause 1 or 2, the voltage application unit includes a high frequency voltage application unit that applies a high frequency voltage to the second focusing electrode. The high frequency voltage application unit may apply the high frequency voltage to the second focusing electrode to form high frequency electric field that focuses ions focused by the first focusing electrode from the second focusing electrode toward a center of the introduction port.

According to the mass spectrometer according to Clause 3, high frequency electric field can focus ions to further be directed toward the center of the introduction port and efficiency in taking ions into the ion introduction portion can further be improved.

(Clause 4) In the mass spectrometer according to Clause 3, the second focusing electrode may be arranged between the first focusing electrode and the introduction port of the ion introduction portion.

According to the mass spectrometer according to Clause 4, since positions of the first focusing electrode, the second focusing electrode, and the ion introduction portion are not superimposed on one another, each component is readily provided.

(Clause 5) In the mass spectrometer according to Clause 3 or 4, the second focusing electrode may be an ion funnel type electrode or a multipole ion guide type electrode.

(Clause 6) In the mass spectrometer according to Clause 1 or 2, the voltage application unit may include a DC voltage application unit that applies a DC voltage to the second focusing electrode.

According to the mass spectrometer according to Clause 6, by application of a DC voltage, electric field extending from the second focusing electrode toward the introduction port can be formed, ions can be focused to further be directed toward the center of the introduction port, and efficiency in taking ions into the ion introduction portion can be improved. Use of a DC voltage can facilitate design of a circuit or grounding as compared with an example where a high frequency voltage is used.

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. A mass spectrometer that generates ions by an atmospheric pressure ionization method and separates and detects generated ions in accordance with a mass-to-charge ratio, the mass spectrometer comprising:
an ion source including a probe that sprays a liquid sample into an ionization chamber which is in an atmospheric-pressure atmosphere;
an ion introduction portion where ions in a sample droplet sprayed from the probe are introduced from the ionization chamber toward a vacuum chamber in a direction intersecting with a direction of spray of the liquid sample from the probe;
a reflecting electrode arranged at a position opposed to an introduction port of the ion introduction portion with a spray flow lying between the introduction port and the reflecting electrode;
a first focusing electrode arranged at a position opposed to the reflecting electrode with the spray flow lying between the reflecting electrode and the first focusing electrode, the first focusing electrode focusing ions reflected or deflected by the reflecting electrode;
a second focusing electrode arranged at a position opposed to the reflecting electrode with the spray flow lying between the reflecting electrode and the second focusing electrode, the second focusing electrode focusing ions focused by the first focusing electrode toward the introduction port; and
a voltage application unit that applies a voltage to each electrode to form electric field where ions in the spray flow are directed toward the first focusing electrode, directed from the first focusing electrode toward the second focusing electrode, and directed from the second focusing electrode toward the introduction port.

2. The mass spectrometer according to claim 1, wherein
the first focusing electrode defines a first transmission channel,
the second focusing electrode defines a second transmission channel, and
the first focusing electrode, the second focusing electrode, and the ion introduction portion are arranged such that, when the introduction port is viewed from the reflecting electrode in a plan view, an inner edge of the second transmission channel is located as being flush with or on an inner side of an inner edge of the first transmission channel and the introduction port is located as being flush with or on an inner side of the inner edge of the second transmission channel.

3. The mass spectrometer according to claim 1, wherein
the voltage application unit includes a high frequency voltage application unit that applies a high frequency voltage to the second focusing electrode, and
the high frequency voltage application unit applies the high frequency voltage to the second focusing electrode to form high frequency electric field that focuses ions focused by the first focusing electrode from the second focusing electrode toward a center of the introduction port.

4. The mass spectrometer according to claim 3, wherein
the second focusing electrode is arranged between the first focusing electrode and the introduction port of the ion introduction portion.

5. The mass spectrometer according to claim 3, wherein
the second focusing electrode is an ion funnel type electrode or a multipole ion guide type electrode.

6. The mass spectrometer according to claim 1, wherein
the voltage application unit includes a DC voltage application unit that applies a DC voltage to the second focusing electrode.
